(19) United States
(12) Patent Application Publication
(10) Pub. No.: US 2023/0402026 A1
(43) Pub. Date: Dec. 14, 2023

(54) AUDIO PROCESSING METHOD AND APPARATUS, AND DEVICE AND MEDIUM

(71) Applicant: Tencent Music Entertainment Technology (Shenzhen) Co., Ltd., Shenzhen (CN)

(72) Inventors: Zebin Wu, Shenzhen (CN); Yuanqing Rui, Shenzhen (CN); Yiyong Jiang, Shenzhen (CN); Shuo Cao, Shenzhen (CN)

(73) Assignee: Tencent Music Entertainment Technology (Shenzhen) Co., Ltd., Shenzhen (CN)

(21) Appl. No.: 18/034,032

(22) PCT Filed: Oct. 8, 2021
(86) PCT No.: PCT/CN2021/122559

§ 371 Date: Apr. 26, 2023

(30) Foreign Application Priority Data
Nov. 3, 2020 (CN) 202011210970.6

(51) Int. Cl. G10H 1/38; G10H 1/00

(52) U.S. Cl. CPC G10H 1/38; G10H 1/0066; G10H 2210/066; G10H 2210/076

(57) ABSTRACT

An audio processing method, an apparatus, a device and a medium are provided. The method includes: acquiring a to-be-processed humming audio and music information corresponding to the to-be-processed humming audio, the music information including note information and beat per minute information; determining chords corresponding to the to-be-processed humming audio based on the note information and the beat per minute information; generating an MIDI file corresponding to the to-be-processed humming audio based on the note information and the beat per minute information; generating a chord accompaniment audio corresponding to the to-be-processed humming audio based on the beat per minute information, the chords and a pre-acquired chord accompaniment parameter, the chord accompaniment parameter being a chord accompaniment generation parameter set by a user; and outputting the MIDI file and the chord accompaniment audio.

The present application claims priority to Chinese Patent Application No. 202011210970.6, titled “AUDIO PROCESSING METHOD AND APPARATUS, AND DEVICE AND MEDIUM”, filed on Nov. 3, 2020 with the China National Intellectual Property Administration, which is incorporated herein by reference in its entirety.

### FIELD

The present disclosure relates to the field of computer technology, and in particular to an audio processing method, an audio processing apparatus, a device, and a medium.

### BACKGROUND

In creation of original songs, professional musicians need to match chords to scores, and record a main melody and a chord accompaniment played by professional instrumentalists. The above process requires a high level of musical knowledge for the relevant personnel, and the whole process takes a long time and results in a high cost.

In order to solve the above problems, in the conventional art, an acquired user audio is converted into an MIDI (Musical Instrument Digital Interface) file, and then the MIDI file is analyzed to generate an MIDI file corresponding to the chord accompaniment.

The inventors have found that at least the following problems exist in the above conventional art. In the above conventional art, MIDI files are used as input and output, and other methods are used to perform sampling process on the input to obtain MIDI files. This process may cause cumulative errors due to the small amount of information in the MIDI files, incomplete recognition and conversion, and the like. In addition, only MIDI files are generated in the end, and the playback of MIDI files depends on the performance of audio equipment, therefore it is prone to the problem of audio timbre distortion, which may not achieve the expected effect, make user experiences inconsistent during the transmission process.

### SUMMARY

In view of this, the purpose of the disclosure is to provide an audio processing method, an audio processing apparatus, a device, and a medium that can generate a melody rhythm and a chord accompaniment audio corresponding to a user humming audio, and is not prone to cumulative errors, so that different users have consistent music experiences. The specific solutions are as follows.

In order to achieve the above purpose, in a first aspect, an audio processing method is provided. The audio processing method includes: acquiring a to-be-processed humming audio and music information corresponding to the to-be-processed humming audio, the music information including note information and beat per minute information; determining chords corresponding to the to-be-processed humming audio based on the note information and the beat per minute information; generating an MIDI file corresponding to the to-be-processed humming audio based on the note information and the beat per minute information; generating a chord accompaniment audio corresponding to the to-be-processed humming audio based on the beat per minute information, the chords and a pre-acquired chord accompaniment parameter, the chord accompaniment parameter being a chord accompaniment generation parameter set by a user; and outputting the MIDI file and the chord accompaniment audio.

Optionally, the acquiring a to-be-processed humming audio and music information corresponding to the to-be-processed humming audio includes: acquiring the to-be-processed humming audio; determining a target fundamental tone period of each first audio frame in the to-be-processed humming audio, and determining note information corresponding to the first audio frame based on the target fundamental tone period, where the first audio frame has a first preset duration; and determining an acoustic energy of each second audio frame in the to-be-processed humming audio, and determining the beat per minute information corresponding to the to-be-processed humming audio based on the acoustic energy, where the second audio frame includes a preset number of sampling points.

Optionally, the determining a target fundamental tone period of each first audio frame in the to-be-processed humming audio includes: determining the target fundamental tone period of the first audio frame in the to-be-processed humming audio by using a short-time autocorrelation function and a preset unvoiced or voiced sound detection method.

Optionally, determining the target fundamental tone period of the first audio frame in the to-be-processed humming audio by using a short-time autocorrelation function and a preset unvoiced or voiced sound detection method includes: determining a preselected fundamental tone period of the first audio frame in the to-be-processed humming audio by using the short-time autocorrelation function; determining whether the first audio frame is a voiced sound frame by using the preset unvoiced or voiced sound detection method; and determining the preselected fundamental tone period of the first audio frame as the target fundamental tone period of the first audio frame in a case that the first audio frame is a voiced sound frame.

Optionally, the determining note information corresponding to the first audio frame based on the target fundamental tone period includes: determining a pitch of the first audio frame based on the target fundamental tone period; determining a note corresponding to the first audio frame based on the pitch of the first audio frame; and determining the note corresponding to the first audio frame and starting and ending time instants corresponding to the first audio frame as the note information corresponding to the first audio frame

Optionally, the determining an acoustic energy of each second audio frame in the to-be-processed humming audio and determining the beat per minute information corresponding to the to-be-processed humming audio based on the acoustic energy includes: determining an acoustic energy of a current second audio frame and an average acoustic energy corresponding to the current second audio frame in the to-be-processed humming audio, where the average acoustic energy is an average value of acoustic energies of the second audio frames in a continuous second preset duration before an ending time instant of the current second audio frame; constructing a target comparison parameter based on the average acoustic energy; determining whether the acoustic energy of the current second audio frame is greater than the target comparison parameter; and determining, in a case that the acoustic energy of the current second audio frame is greater than the target comparison parameter, that the current second audio frame includes one beat until detection of each second audio frame in the to-be-processed humming audio is completed, to obtain a total number of beats in the to-be-processed humming audio, and determining the beat per minute information corresponding to the to-be-processed humming audio based on the total number of beats.

Optionally, the constructing a target comparison parameter based on the average acoustic energy includes: determining an offset sum of an offset of the acoustic energy of each second audio frame, in the continuous second preset duration before the ending time instant of the current second audio frame, relative to the average acoustic energy; determining a calibration factor for the average acoustic energy based on the offset sum; and calibrating the average acoustic energy based on the calibration factor to obtain the target comparison parameter.

Optionally, the determining chords corresponding to the to-be-processed humming audio based on the note information and the beat per minute information includes: determining a key of the to-be-processed humming audio based on the note information; determining preselected chords from preset chords based on the key of the to-be-processed humming audio; and determining chords corresponding to the to-be-processed humming audio from the preselected chords based on the note information and the beat per minute information.

Optionally, the determining a key of the to-be-processed humming audio based on the note information includes: determining a real-time key feature corresponding to a note sequence in the note information when a preset adjustment parameter takes different values; matching each real-time key feature with a preset key feature, and determining the real-time key feature with a highest matching degree as a target real-time key feature; and determining the key of the to-be-processed humming audio based on a value of the preset adjustment parameter corresponding to the target real-time key feature, and a correspondence between values, of the preset adjustment parameter corresponding to a preset key feature that best matches the target real-time key feature, and keys.

Optionally, the determining chords corresponding to the to-be-processed humming audio from the preselected chords based on the note information and the beat per minute information includes: dividing notes in the note information into different bars according to time sequence based on the beat per minute information; and matching the notes in each bar with each of the preselected chords and determining the chord corresponding to the bar, to determine the chords corresponding to the to-be-processed humming audio.

Optionally, the generating a chord accompaniment audio corresponding to the to-be-processed humming audio based on the beat per minute information, the chords and a pre-acquired chord accompaniment parameter includes: determining whether a chord parameter in the chord accompaniment parameter represents a common chord; optimizing, if the chord parameter in the chord accompaniment parameter represents the common chord, the chords based on a common chord group in a preset common chord library to obtain optimized chords; converting the optimized chords into optimized notes according to a pre-acquired correspondence between chords and notes; determining audio material information corresponding to each note in the optimized notes based on an instrument type parameter and an instrument pitch parameter in the chord accompaniment parameter, and mixing audio materials corresponding to the audio material information according to a preset mixing rule; and writing the mixed audio into a WAV file to obtain the chord accompaniment audio corresponding to the to-be-processed humming audio.

Optionally, the optimizing the chords based on a common chord group in a preset common chord library to obtain optimized chords includes: determining a key of the to-be-processed humming audio based on the note information; grouping the chords to obtain different chord groups; matching a current chord group with each common chord group corresponding to the key in the preset common chord library, and determining the common chord group with a highest matching degree as an optimized chord group corresponding to the current chord group until the optimized chord group corresponding to each chord group is obtained, to obtain the optimized chords.

Optionally, the determining audio material information corresponding to each note in the optimized notes based on an instrument type parameter and an instrument pitch parameter in the chord accompaniment parameter, and mixing audio materials corresponding to the audio material information according to a preset mixing rule includes: determining the audio material information corresponding to each note in the optimized notes based on the instrument type parameter and the instrument pitch parameter in the chord accompaniment parameter, where the audio material information includes a material identifier, a pitch, a starting playback position and a material duration; and putting the audio material information into a preset voice array according to the preset mixing rule, and mixing audio materials in a preset audio material library indicated by the audio material information in the preset voice array for a current beat, where the beat is determined according to the beat per minute information.

In a second aspect, an audio processing apparatus is provided. The audio processing apparatus includes: an audio acquisition module, configured to acquire a to-be-processed humming audio and music information corresponding to the to-be-processed humming audio, the music information including note information and beat per minute information; a chord determination module, configured to determine chords corresponding to the to-be-processed humming audio based on the note information and the beat per minute information; an MIDI file generation module, configured to generate an MIDI file corresponding to the to-be-processed humming audio based on the note information and the beat per minute information; a chord accompaniment generating module, configured to generate a chord accompaniment audio corresponding to the to-be-processed humming audio based on the beat per minute information, the chords and a pre-acquired chord accompaniment parameter, the chord accompaniment parameter being a chord accompaniment generation parameter set by a user; and an output module, configured to output the MIDI file and the chord accompaniment audio.

In a third aspect, an electronic device is provided. The electronic device includes: a memory configured to store computer programs; and a processor configured to execute the computer programs to implement the above audio processing method.

In a fourth aspect, a computer-readable storage medium is provided, The computer-readable storage medium stores computer programs. The computer programs, when executed by a processor, perform the above audio processing method.

It can be seen that in this disclosure, a to-be-processed humming audio and music information corresponding to the to-be-processed humming audio are acquired, the music information includes note information and beat per minute information; then chords corresponding to the to-be-processed humming audio are determined based on the note information and the beat per minute information; an MIDI file corresponding to the to-be-processed humming audio is generated based on the note information and the beat per minute information; a chord accompaniment audio corresponding to the to-be-processed humming audio are generated based on the beat per minute information, the chords and a pre-acquired chord accompaniment parameter, and finally the MIDI file and the chord accompaniment audio are outputted. It can be seen that in this disclosure, corresponding music information can be obtained after the to-be-processed humming audio is acquired. Compared with the conventional art, it is not necessary to first convert the to-be-processed humming audio into a MIDI file, and then analyze the MIDI file, therefore, it is not prone to the problem of cumulative errors caused by converting the audio to the MIDI file. In addition, not only the MIDI file corresponding to a main melody audio needs to be generated based on the music information, but also the corresponding chord accompaniment audio needs to be generated according to the music information and the chords. Compared with the problem of inconsistency user experiences in the conventional art cause by only generating the MIDI file corresponding to chord accompaniment, in this disclosure, not only the MIDI file corresponding to a main melody of the to-be-processed humming audio is generated, but also the corresponding chord accompaniment of the to-be-processed humming audio is generated. The chord accompaniment audio is less dependent on the performance of the audio device, therefore the experiences of different users are consistent, and the expected user experience effect is achieved.

### BRIEF DESCRIPTION OF THE DRAWINGS

In order to more clearly illustrate the technical solutions in the embodiments of the present disclosure or the conventional art, the drawings that need to be used in the description of the embodiments or the conventional art may be briefly introduced below. Apparently, the accompanying drawings in the following description only show embodiments of the present disclosure, and those skilled in the art can also obtain other drawings according to the provided drawings without creative work.

FIG. 1 is a schematic diagram of a system framework applicable to an audio processing solution according to the present disclosure;

FIG. 2 is a flowchart of an audio processing method according to the present disclosure;

FIG. 3 is a flowchart of an audio processing method according to the present disclosure;

FIG. 4 is a note comparison diagram according to the present disclosure;

FIG. 5 is a note detection result diagram according to the present disclosure;

FIG. 6 is a tonic table according to the present disclosure;

FIG. 7 is a flowchart of an audio processing method according to the present disclosure;

FIG. 8 is a chord and note comparison table;

FIG. 9 is an arpeggio and note comparison table;

FIG. 10 is a flowchart of mixing audio materials according to the present disclosure;

FIG. 11a is an APP application interface according to the present disclosure;

FIG. 11b is an APP application interface according to the present disclosure;

FIG. 11c is an APP application interface according to the present disclosure;

FIG. 12 is a schematic structural diagram of an audio processing apparatus according to the present disclosure;

FIG. 13 is a schematic structural diagram of an electronic device according to the present disclosure.

### DETAILED DESCRIPTION

The technical solutions in the embodiments of the disclosure are clearly and completely described with reference to the drawings in the embodiments of the disclosure. Apparently, the described embodiments are only part of the embodiments of the disclosure. Based on the embodiments in this disclosure, all other embodiments obtained by persons of ordinary skill in the art without making creative efforts belong to the protection scope of this disclosure.

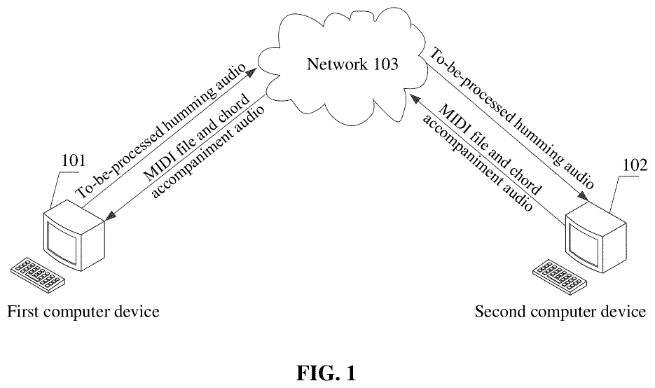

For ease of understanding, the system framework applicable to the audio processing method of the present disclosure is introduced first. It can be understood that the number of computer devices is not limited in this embodiment of the present disclosure, and there may be a case that multiple computer devices work together to complete an audio processing function. In a possible scenario, reference is made to FIG. 1, a hardware composition framework may include a first computer device 101 and a second computer device 102. The communication connection between the first computer device 101 and the second computer device 102 is realized through a network 103.

In this embodiment of the present disclosure, the hardware structures of the first computer device 101 and the second computer device 102 are not specifically limited here, and the first computer device 101 and the second computer device 102 perform data interaction to realize the audio processing function. Further, the form of the network 103 is not limited in the embodiment of the present disclosure, for example, the network 103 may be a wireless network (such as WIFI, Bluetooth), or a wired network.

The first computer device 101 and the second computer device 102 may be the same computer device, such as both the first computer device 101 and the second computer device 102 are servers. The first computer device 101 and the second computer device 102 may also be different types of computer devices, such as the first computer device 101 may be a terminal or an intelligent electronic device, and the second computer device 102 may be a server. In yet another possible situation, a server with strong computing power may be used as the second computer device 102 to improve a data processing efficiency and reliability, and further improve an audio processing efficiency. In addition, a terminal or an intelligent electronic device with a low cost and a wide application range is used as the first computer device 101 to realize the interaction between the second computer device 102 and the user.

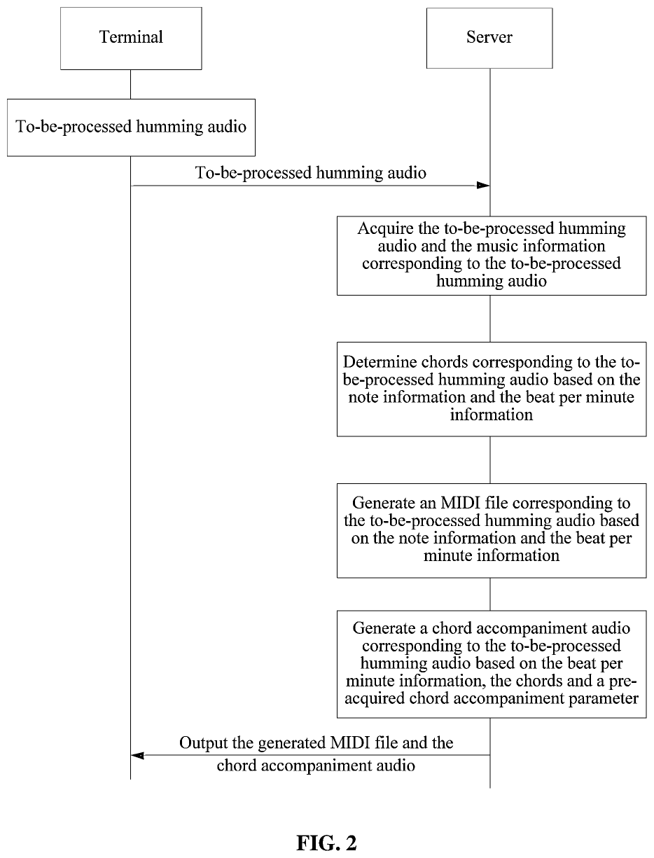

For example, reference is made to FIG. 2, after a terminal obtains a to-be-processed humming audio, the terminal sends the to-be-processed humming audio to a server corresponding to the terminal. After receiving the to-be-processed humming audio, the server obtains music information corresponding to the to-be-processed humming audio. The music information includes note information and beat per minute information. The server determines chords corresponding to the to-be-processed humming audio based on the note information and the beat per minute information, generates an MIDI file corresponding to the to-be-processed humming audio based on the note information and the beat per minute information, generates a chord accompaniment audio corresponding to the to-be-processed humming audio based on the beat per minute information, the chords and a pre-acquired chord accompaniment parameter; and then outputs the generated MIDI file and the chord accompaniment audio to the terminal. When the terminal receives a first playback instruction triggered by the user, the terminal acquires the MIDI file and plays the corresponding audio. When the terminal receives a second playback instruction triggered by the user, the terminal plays the obtained chord accompaniment audio.

Apparently, in practice, the entire aforementioned audio processing process may also be completed by the terminal. That is, a voice collection module of the terminal acquires a to-be-processed humming audio and music information corresponding to the to-be-processed humming audio. The music information includes note information and beat per minute information. The terminal determines chords corresponding to the to-be-processed humming audio based on the note information and the beat per minute information, generates an MIDI file corresponding to the to-be-processed humming audio based on the note information and the beat per minute information, generates a chord accompaniment audio corresponding to the to-be-processed humming audio based on the beat per minute information, the chords and a pre-acquired chord accompaniment parameter; and then outputs the generated MIDI file and the chord accompaniment audio to a corresponding path for preservation. When the terminal receives a first playback instruction triggered by the user, the terminal acquires the MIDI file and plays the corresponding audio. When the terminal receives a second playback instruction triggered by the user, the terminal plays the obtained chord accompaniment audio.

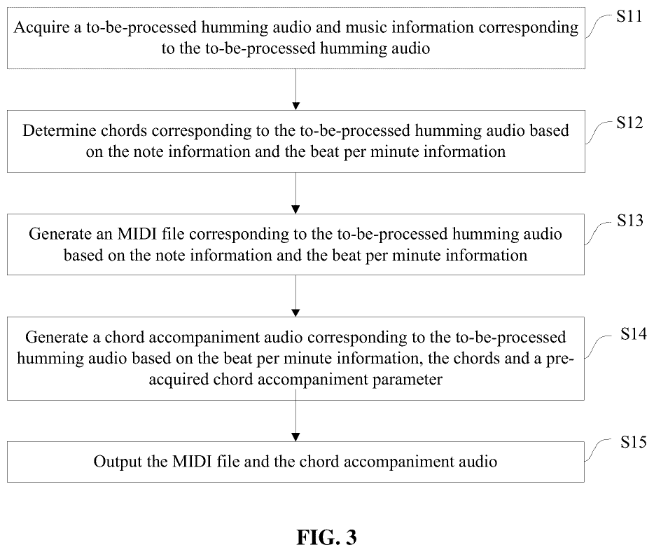

Referring to FIG. 3, the embodiment of the present disclosure discloses an audio processing method, which includes steps S11 to S15.

Step S11: acquire a to-be-processed humming audio and music information corresponding to the to-be-processed humming audio, the music information includes note information and beat per minute information.

In a specific implementation process, it is necessary to acquire the to-be-processed humming audio first, so as to obtain the music information corresponding to the to-be-processed humming audio. The to-be-processed humming audio may be a user humming audio collected by a voice collection device. Specifically, the to-be-processed humming audio may be acquired first, and then music information retrieval is performed on the to-be-processed humming audio to obtain the music information corresponding to the to-be-processed humming audio. The music information includes the note information and the beat per minute information.

Music information retrieval includes pitch/melody extraction, automatic notation, rhythm analysis, harmony analysis, singing information processing, music search, music structure analysis, music emotion calculation, music recommendation, music classification, and automatic composition, singing voice synthesis and digital instrument sound synthesis in music generation, or the like.

In practice, acquiring the to-be-processed humming audio by the current computer device includes acquiring the to-be-processed humming audio through an input unit of the current computer device. For example, the current computer device collects the to-be-processed humming audio through the voice collection module, or the current computer device acquires the to-be-processed humming audio from a cappella audio library, where the cappella audio library may include pre-acquired different user cappella audios. The current computer device may also acquire the to-be-processed humming audio sent by other devices through the network (which may be a wired network or a wireless network). Apparently, a manner that other devices (such as other computer devices) acquire the to-be-processed humming audio is not limited in this embodiment of the disclosure. For example, other devices (such as terminals) may receive the to-be-processed humming audio inputted by the user through a voice input module.

Specifically, the acquiring a to-be-processed humming audio and music information corresponding to the to-be-processed humming audio includes: acquiring the to-be-processed humming audio; determining a target fundamental tone period of each first audio frame in the to-be-processed humming audio, and determining note information corresponding to the first audio frame based on the target fundamental tone period, where the first audio frame has a first preset duration; and determining an acoustic energy of each second audio frame in the to-be-processed humming audio, and determining the beat per minute information corresponding to the to-be-processed humming audio based on the acoustic energy, where the second audio frame includes a preset number of sampling points.

That is, the target fundamental tone period of each first audio frame in the to-be-processed humming audio is determined first, and note information corresponding to the first audio frame is determined based on the target fundamental tone period. A audio frame division method is to take an audio with the continuous first preset duration into one first audio frame. For fundamental tone detection, it is generally required that one frame contains at least two or more periods, usually the minimum pitch is 50 Hz, that is, the greatest period is 20 ms, therefore a frame length of one first audio frame is generally required to be greater than 40 ms.

The determining a target fundamental tone period of each first audio frame in the to-be-processed humming audio includes: determining the target fundamental tone period of the first audio frame in the to-be-processed humming audio by using a short-time autocorrelation function and a preset unvoiced or voiced sound detection method.

When a person is pronouncing, according to vibration of a vocal cord, a speech signal may be divided into two types: unvoiced sound and voiced sound. The voiced sound shows obvious periodicity in the time domain. The speech signal is a non-stationary signal, and the feature of the speech signal changes with time. However, the speech signal may be considered to have a relatively stable feature in a short period of time, that is, the speech signal has short-time stationarity. Therefore, the target fundamental tone period of the first audio frame in the to-be-processed humming audio may be determined by using a short-time autocorrelation function and a preset unvoiced or voiced sound detection method.

Specifically, a preselected fundamental tone period of the first audio frame in the to-be-processed humming audio is determined by using the short-time autocorrelation function, it is determined whether the first audio frame is a voiced sound frame by using the preset unvoiced or voiced sound detection method; and the preselected fundamental tone period of the first audio frame is determined as the target fundamental tone period of the first audio frame in a case that the first audio frame is a voiced sound frame. That is, for the current first audio frame, a preselected fundamental tone period of the current first audio frame is determined by using the short-time autocorrelation function, it is determined whether the current first audio frame is a voiced sound frame by using the preset unvoiced or voiced sound detection method; and the preselected fundamental tone period of the current first audio frame is determined as the target fundamental tone period of the current first audio frame in a case that the current first audio frame is a voiced sound frame. The preselected fundamental tone period of the current first audio frame is determined as an invalid fundamental tone period in a case that the current first audio frame is an unvoiced sound frame.

The determining whether the current first audio frame is a voiced sound frame by using the preset unvoiced or voiced sound detection method may include: determining whether the current first audio frame is a voiced sound frame by judging whether a ratio, of the energy of an voiced sound segment to the energy of an unvoiced sound segment in the current first audio frame, is greater than or equal to a preset energy ratio threshold. The voiced sound segment usually ranges from 100 Hz to 4000 Hz, and the unvoiced sound segment usually ranges from 4000 Hz to 8000 Hz, so the unvoiced or voiced sound segment usually ranges from 100 Hz to 8000 Hz. In addition, other unvoiced or voiced sound detection methods may also be used, which are not specifically limited here.

After the target fundamental tone period of the first audio frame is determined, note information corresponding to the first audio frame may be determined based on the target fundamental tone period. Specifically, a pitch of the first audio frame is determined based on the target fundamental tone period; a note corresponding to the first audio frame is determined based on the pitch of the first audio frame; and the note corresponding to the first audio frame and starting and ending time instants corresponding to the first audio frame are determined as the note information corresponding to the first audio frame.

A process of determining the note information corresponding to the first audio frame based on the target fundamental tone period is expressed by a first calculation formula as:

$$note = 69 + 12 * {log}_{2} \frac{p i t c h}{440} , pitch = \frac{1}{T}$$

note represents the note corresponding to the current first audio frame, pitch represents the pitch corresponding to the current first audio frame, and T represents the target fundamental tone period of the current first audio frame.

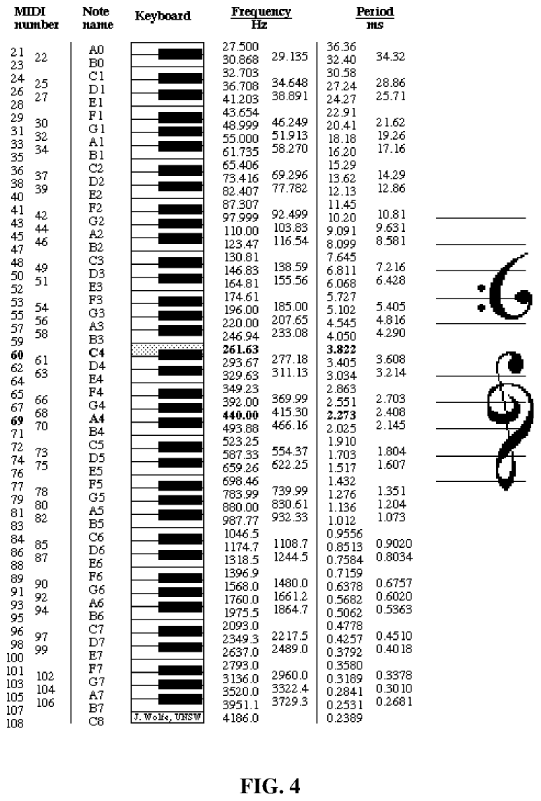

FIG. 4 shows a correspondence between notes in a music and notes, frequencies, and periods on the piano. It can be known from FIG. 4 that, for example, when the pitch is 220 Hz, the note is the 57th note, which corresponds to the A3 note on the piano.

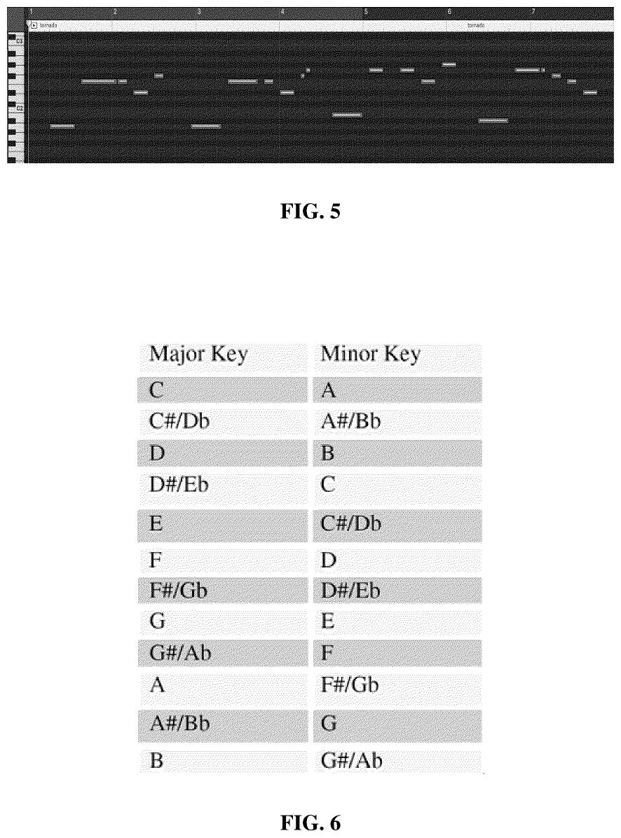

Usually, a calculated note is a decimal, an integer nearest the decimal is taken as the value of the note. Starting and ending time instants corresponding to the current note are recorded. When no voiced sound is detected, the current note is considered to be other interference or pause, which is not valid humming. In this way, a string of discretely distributed note sequences may be obtained, which may be expressed in the form of a piano roll as shown in FIG. 5.

In practice, the determining an acoustic energy of each second audio frame in the to-be-processed humming audio and determining the beat per minute information corresponding to the to-be-processed humming audio based on the acoustic energy includes: determining an acoustic energy of a current second audio frame and an average acoustic energy corresponding to the current second audio frame in the to-be-processed humming audio, where the average acoustic energy is an average value of acoustic energies of the second audio frames in a continuous second preset duration before an ending time instant of the current second audio frame; constructing a target comparison parameter based on the average acoustic energy; determining whether the acoustic energy of the current second audio frame is greater than the target comparison parameter; and determining, in a case that the acoustic energy of the current second audio frame is greater than the target comparison parameter, that the current second audio frame includes one beat until detection of each second audio frame in the to-be-processed humming audio is completed, to obtain a total number of beats in the to-be-processed humming audio, and determining the beat per minute information corresponding to the to-be-processed humming audio based on the total number of beats.

The constructing a target comparison parameter based on the average acoustic energy includes: determining an offset sum of an offset of the acoustic energy of each second audio frame, in the continuous second preset duration before the ending time instant of the current second audio frame, relative to the average acoustic energy; determining a calibration factor for the average acoustic energy based on the offset sum; and calibrating the average acoustic energy based on the calibration factor to obtain the target comparison parameter. The above process may be expressed by a second calculation formula as:

$$P = C \cdot avg ( E )$$

$$C = - 0.0000015 var ( E ) + 1.5142 \; 857$$

$$var ( E ) = \frac{1}{N} {\sum }_{k = 1}^{N} {( avg ( E ) - {E}_{k} )}^{2}$$

$$avg ( E ) = \frac{1}{N} {\sum }_{k = 1}^{N} {E}_{k}$$

$${E}_{j} = {\sum }_{i = 1}^{M} {input}_{i}^{2}$$

P represents the target comparison parameter of the current second audio frame, C represents the calibration factor of the current second audio frame, Eⱼ represents the acoustic energy of the current second audio frame, var(E) represents the offset sum of an offset of the acoustic energy of each second audio frame, in the continuous second preset duration before the ending time instant of the current second audio frame, relative to the average acoustic energy, N represents a total number of the second audio frames in the continuous second preset duration before the ending time instant of the current second audio frame, M represents a total number of sampling points in the current second audio frame, and input, represents a value of the i-th sampling point in the current second audio frame.

Taking 1024 sampling points per frame as an example, the energy of the current frame is first calculated as follows:

$${E}_{j} = {\sum }_{i = 1}^{1024} {input}_{i}^{2}$$

Then the energy of this frame is stored in a circular buffer, and the energies of all frames in the past one second are recorded. Taking a sampling rate of 44100 Hz as an example, the energies of 43 frames are stored, and the average energy in the past one second is calculated as follows:

$$avg ( E ) = \frac{1}{43} {\sum }_{k = 1}^{43} {E}_{k}$$

If the energy of the current frame is greater than P, it is determined that one beat is detected. P is calculated as follows.

$$P = C \cdot avg ( E )$$

$$C = - 0.0000015 var ( E ) + 1.5142 \; 857$$

$$var ( E ) = \frac{1}{43} {\sum }_{k = 1}^{43} {( a v g ( E ) - {E}_{k} )}^{2}$$

Until the detection is completed, the total number of beats included in the to-be-processed humming audio is obtained, and the total number of beats is divided by the corresponding duration of the to-be-processed humming audio, the duration is in a unit of minute, that is, the total number of beats is converted into the number of beats in one minute, i.e., beats per minute (BPM). After getting the BPM, taking 4/4 beat as an example, the duration of each bar may be calculated as 4*60/BPM.

In practice, because there are more interferences in the first one second, the beat is usually detected from the first second audio frame starting from the lth second, that is, starting from the lth second, every 1024 sampling points are used as one second audio frame. For example, the continuous 1024 sampling points starting from the lth second are taken as the first second audio frame, and then the acoustic energy of this second audio frame is calculated and the average acoustic energy of acoustic energies of the second audio frames in the past one second before the 1024th sampling point starting from the lth second, then subsequent operations are performed.

Step S12: determine chords corresponding to the to-be-processed humming audio based on the note information and the beat per minute information.

After the music information corresponding to the to-be-processed humming audio is determined, the chords corresponding to the to-be-processed humming audio may be determined based on the note information and the beat per minute information.

Specifically, a key of the to-be-processed humming audio is determined based on the note information; preselected chords are determined from preset chords based on the key of the to-be-processed humming audio; and chords corresponding to the to-be-processed humming audio are determined from the preselected chords based on the note information and the beat per minute information. The preset chords are set in advance, different keys correspond to different preset chords, and the preset chords can be expanded, that is, chords may be added to the preset chords.

The determining a key of the to-be-processed humming audio based on the note information includes: determining a real-time key feature corresponding to a note sequence in the note information when a preset adjustment parameter takes different values; matching each real-time key feature with a preset key feature, and determining the real-time key feature with a highest matching degree as a target real-time key feature; and determining the key of the to-be-processed humming audio based on a value of the preset adjustment parameter corresponding to the target real-time key feature, and a correspondence between values, of the preset adjustment parameter corresponding to a preset key feature that best matches the target real-time key feature, and keys.

Before matching the chord pattern, the key of the humming audio has to be determined firstly, that is, the tonic and the key mode of the humming audio have to be determined. The key mode include a major key and a minor key, and there are 12 tonics and 24 keys. An interval relationship between each tone in the major key and the minor key is as follows:

| | | | | | | | | |
|---|---|---|---|---|---|---|---|---|
| Major key: | 0 | 2 | 4 | 5 | 7 | 9 | 11 | 12(0) |
| | whole | whole | half | whole | whole | whole | half | |
| Minor key: | 0 | 2 | 3 | 5 | 7 | 8 | 10 | 12(0) |
| | whole | half | whole | whole | half | whole | whole | |

That is, in the major key, the interval relationships between two tones starting from the tonic are whole tone, whole tone, half tone, whole tone, whole tone, whole tone, half tone in sequence. In the minor key, the interval relationships between two tones starting from the tonic are whole tone, half tone, whole tone, whole tone, half tone, whole tone, whole tone in sequence.

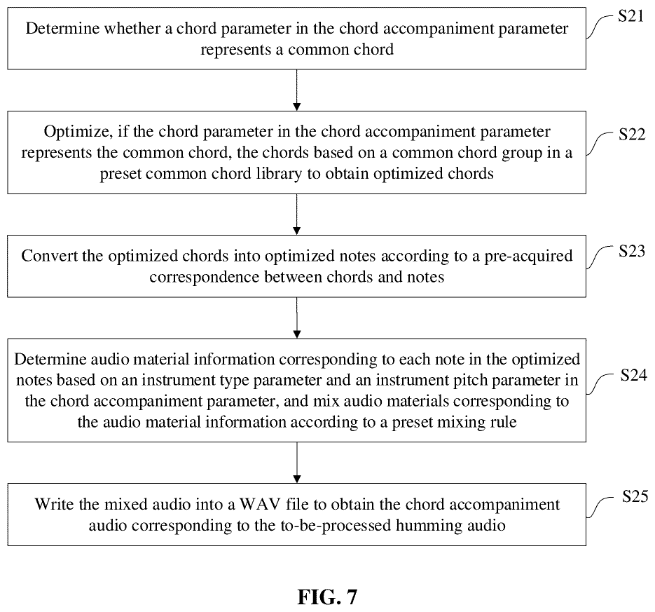

FIG. 6 shows 12 tonics of the major key and 12 tonics of the minor key. The left column of FIG. 6 shows the major key, and the right column of FIG. 6 shows the minor key. “#” represents a half tone up, and “b” represents a half tone down. That is, there are a total of 12 major keys, namely C major key, C #major key, D major key, D #major key, E major key, F major key, F #major key, G major key, G #major key, A major key, A #major key, B major key. There are a total of 12 minor keys, namely A minor key, A #minor key, B minor key, C minor key, C #minor key, D minor key, D #minor key, E minor key, F minor key, F #minor key, G minor key, G #minor key.

shift may be used to represent the preset adjustment parameter, and shift may range from 0 to 11. The real-time key feature corresponding to the note sequence in the note information is determined when the preset adjustment parameter takes different values. That is, when the preset adjustment parameter takes different values, a modulus value of each note in the note sequence of the note information is determined through a third calculation formula, and the modulus value of each note when the preset adjustment parameter takes a current value, is used as the real-time key feature corresponding to the note sequence in the note information. The third calculation formula is:

Mᵢ=(note_array[i]+shift) %12

Mᵢ represents the modular value corresponding to an i-th note in the note sequence, note_array[i] represents an MIDI value of the i-th note in the note sequence, % represents a modulo operation, and shift represents the preset adjustment parameter ranging from 0 to 11.

The corresponding real-time key feature is obtained when the preset adjustment parameter takes different values; each real-time key feature is matched with the preset key feature, and the real-time key feature with a highest matching degree is determined as the target real-time key feature. The preset key feature include a key feature (0 2 4 5 7 9 11 12) of C major key and a key feature (0 2 3 5 7 8 10 12) of C minor key. Specifically, each real-time key feature is matched with each of the above two key features, and the real-time key feature, which has more modulus values falling into the two preset key features, is determined as the target real-time key feature. For example, each of the real-time key features S, H, and X includes 10 modulus values, and there are 10 modulus values of the real-time key feature S falling into the key feature of C major key, there are 5 modulus values of the real-time key feature S falling into the key feature of C minor key. There are 7 modulus values of the real-time key feature H falling into the key feature of C major key, there are 4 modulus values of the real-time key feature H falling into the key feature of C minor key. There are 6 modulus values of the real-time key feature X falling into the key feature of C major key, there are 8 modulus values of the real-time key feature X falling into the key feature of C minor key. Then the real-time key feature S has the highest matching degree with the key feature of C major key, and the real-time key feature S is determined as the target real-time key feature.

The correspondence between values of the preset adjustment parameter and keys corresponding to C major key is as follows. shift being 0 corresponds to C major key; shift being 1 corresponds to B major key; shift being 2 corresponds to A #major key; shift being 3 corresponds to A major key; shift being 4 corresponds to G #major key; shift being 5 corresponds to G major key; shift being 6 corresponds to F #major key; shift being 7 corresponds to F major key; shift being 8 corresponds to E major key; shift being 9 corresponds to D #major key; shift being 10 corresponds to D major key; and shift being 11 corresponds to C #major key.

The correspondence between values of the preset adjustment parameter and keys corresponding to C minor key is as follows. shift being 0 corresponds to C minor key; shift being 1 corresponds to B minor key; shift being 2 corresponds to A #minor key; shift being 3 corresponds to A minor key; shift being 4 corresponds to G #minor key; shift being 5 corresponds to G minor key; shift being 6 corresponds to F #minor key; shift being 7 corresponds to F minor key; shift being 8 corresponds to E minor key; shift being 9 corresponds to D #minor key; shift being 10 corresponds to D minor key; and shift being 11 corresponds to C #minor key.

Therefore, the key of the to-be-processed humming audio is determined based on a value of the preset adjustment parameter corresponding to the target real-time key feature, and a correspondence between values, of the preset adjustment parameter corresponding to a preset key feature that best matches the target real-time key feature, and keys. For example, after the above-mentioned real-time key feature S is determined as the target real-time key feature, C major key is most matched with the real-time key feature S, therefore, if shift corresponding to the real-time key feature S is 2, a key of the to-be-processed humming audio is A #major key.

After the key of the to-be-processed humming audio is determined, preselected chords are determined from preset chords based on the key of the to-be-processed humming audio. That is, a preset chord corresponding to each key is preset, different keys may correspond to different preset chords. In this case, after the key of the to-be-processed humming audio is determined, the preselected chords are determined from the preset chords based on the key of the to-be-processed humming audio.

C major key is a scale made up of 7 notes, C key includes 7 chords. Details are as follows:
(1) the tonic is a 1 3 5 major chord;
(2) the supertonic is a 2 4 6 minor chord;
(3) the mediant is a 3 5 7 minor chord;
(4) the subdominant is a 4 6 1 major chord;
(5) the dominant is a 5 7 2 major chord;
(6) the submediant is a 6 1 3 minor chord; and
(7) the leading tone is a 7 2 4 diminished chord.

C major key has three major chords, which are C i.e. (1), F i.e. (4), G i.e. (5). C major key has three minor chords, which are Dm i.e. (2), Em i.e. (3), Am i.e. (6). C major key has one diminished chord, which is Bdmin i.e. (7). m represents a minor chord, and dmin represents a diminished chord.

For the specific concepts of the tonic, the supertonic, the mediant, the subdominant, the dominant, the submediant and the leading tone described in the above seven chords, reference may be made to the conventional art, and no specific explanation is given here.

C minor chords include Cm (1-b3-5), Ddim (2-4-b6), bE (b3-5-7), Fm (4-b6-1), G7 (5-7-2-4), bA (b6-1-b3), bB (b7-b2-4).

When the key is C #minor key, the preset chords are shown in Table 1 below, and the diminished chord is not considered in this case.

TABLE 1

| | | | | | | | |
|---|---|---|---|---|---|---|---|
| 7 chords | 1 | 2 | 3 | 4 | 5 | 6 | 7 |
| minor interval | 0 | 2 | 3 | 5 | 7 | 8 | 10 |
| C# minor interval | 1 | 3 | 4 | 6 | 8 | 9 | 11 |
| minor chord | C#m | — | | F#m | G#m | | |
| major chord | | | E | | | A | B |
| major and minor seventh | | | E7 | | | A7 | B7 |
| chords | | | | | | | |

Specifically, the minor chords C #, E, G # with C # as the root, the minor chords F #, A, C # with F # as the root, the minor chords G #, B, D # with G # as the root, and major chords with E, A, and B as roots, and major and minor seventh chords with E, A, and B as roots.

When the key of the to-be-processed humming audio is C #minor key, the 9 chords in the table above are determined as the preselected chords corresponding to the to-be-processed humming audio, then chords corresponding to the to-be-processed humming audio are determined from the preselected chords based on the note information and the beat per minute information. Specifically, notes in the note information are divided into different bars according to time sequence based on the beat per minute information; and the notes in each bar are matched with each of the preselected chords and the chord corresponding to the bar is determined, to determine the chords corresponding to the to-be-processed humming audio.

For example, the notes of the first bar are E, F, G #, D #, and for major chords, the interval relationship is 0, 4, 7. When the key of the to-be-processed humming audio is C#minor key, if there is a note falling into E+0, E+4, E+7, then 1 is added to the count, and it is found that E(1)+4=G #. The value in the bracket of E(1) indicates the number of notes currently falling into the major chord E, it is indicated that there is another note falling into the major chord E in the current bar, E(2)+7=B. In this case, it may be determined that there are 2 notes falling into the major chord E in the first bar. The number of notes falling into all chord patterns in the first bar is counted, the chord pattern, into which the largest number of notes falling, is the chord corresponding to the bar.

After determining the chord corresponding to each bar in the to-be-processed humming audio, the chords corresponding to the to-be-processed humming audio are determined.

Step S13: generate an MIDI file corresponding to the to-be-processed humming audio based on the note information and the beat per minute information.

After the chords corresponding to the to-be-processed humming audio is determined, the MIDI file corresponding to the to-be-processed humming audio may be generated based on the note information and the beat per minute information.

MIDI refers to musical instrument digital interface. Most digital products that can play audio support the playback of such files. Unlike wave files, MIDI files don't sample the audio, but record each note of the music as a number, so the MIDI file occupies less storage than the wave file. The MIDI standard specifies the mix and sound of various tones, instruments, and the numbers may be resynthesized into music through an output device.

The BPM corresponding to the to-be-processed humming audio is obtained by calculation, that is, rhythm information is obtained, and the starting and ending time instants of the note sequence are obtained, these information may be encoded into a MIDI file according to the MIDI format.

Step S14: generate a chord accompaniment audio corresponding to the to-be-processed humming audio based on the beat per minute information, the chords and a pre-acquired chord accompaniment parameter.

After the chords corresponding to the to-be-processed humming audio is determined, the chord accompaniment audio corresponding to the to-be-processed humming audio may be generated based on the beat per minute information, the chords and the pre-acquired chord accompaniment parameter. The chord accompaniment parameter is a chord accompaniment generation parameter set by a user. In a specific implementation, the chord accompaniment parameter may be a default chord accompaniment generation parameter selected by the user, or may be a chord accompaniment generation parameter specifically set by the user.

Step S15: output the MIDI file and the chord accompaniment audio.

It may be understood that after the MIDI file and the chord accompaniment audio are generated, the MIDI file and the chord accompaniment audio may be outputted. The outputting the MIDI file and the chord accompaniment audio may be transferring the MIDI file and the chord accompaniment audio from one device to another device, or outputting the MIDI file and the chord accompaniment audio to a specific path for storage and playing the MIDI file and the chord accompaniment audio, which is not specifically limited here and may be determined according to specific conditions.

It can be seen that in this disclosure, a to-be-processed humming audio and music information corresponding to the to-be-processed humming audio are acquired, the music information includes note information and beat per minute information; then chords corresponding to the to-be-processed humming audio are determined based on the note information and the beat per minute information; an MIDI file corresponding to the to-be-processed humming audio is generated based on the note information and the beat per minute information; a chord accompaniment audio corresponding to the to-be-processed humming audio are generated based on the beat per minute information, the chords and a pre-acquired chord accompaniment parameter, and finally the MIDI file and the chord accompaniment audio are outputted. It can be seen that in this disclosure, corresponding music information can be obtained after the to-be-processed humming audio is acquired. Compared with the conventional art, it is not necessary to first convert the to-be-processed humming audio into a MIDI file, and then analyze the MIDI file, therefore, it is not prone to the problem of cumulative errors caused by converting the audio to the MIDI file. In addition, not only the MIDI file corresponding to a main melody audio needs to be generated based on the music information, but also the corresponding chord accompaniment audio needs to be generated according to the music information and the chords. Compared with the problem of inconsistency user experiences in the conventional art cause by only generating the MIDI file corresponding to chord accompaniment, in this disclosure, not only the MIDI file corresponding to a main melody of the to-be-processed humming audio is generated, but also the corresponding chord accompaniment of the to-be-processed humming audio is generated. The chord accompaniment audio is less dependent on the performance of the audio device, therefore the experiences of different users are consistent, and the expected user experience effect is achieved.

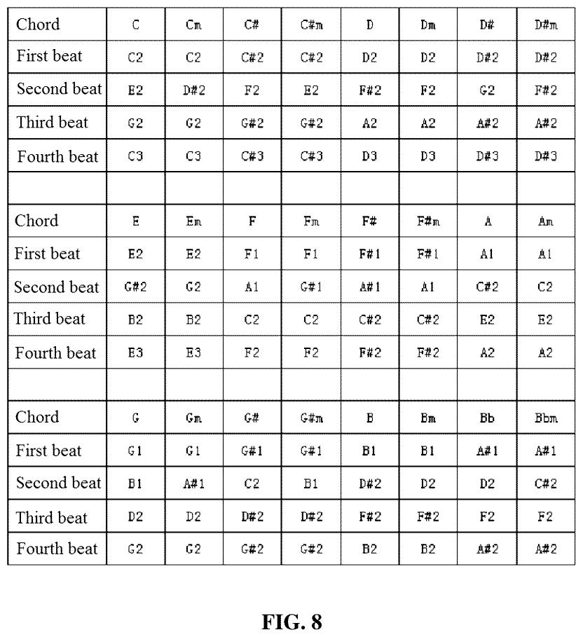

Referring to FIG. 7, the generating a chord accompaniment audio corresponding to the to-be-processed humming audio based on the beat per minute information, the chords and a pre-acquired chord accompaniment parameter includes steps S21 to S25.

Step S21: determine whether a chord parameter in the chord accompaniment parameter represents a common chord.

First of all, it is necessary to determine whether the chord parameter in the obtained chord accompaniment parameter represents a common chord. If the chord parameter represents the common chord, it means that the chords determined above need to be optimized in order to avoid chord dissonance caused by a user humming error. If the chord parameter represents a free chord, the chord may be directly used as the optimized chord.

Step S22: optimize, if the chord parameter in the chord accompaniment parameter represents the common chord, the chords based on a common chord group in a preset common chord library to obtain optimized chords.

Correspondingly, when the chord parameter represents the common chord, the chords needs to be optimized based on the common chord group in the preset common chord library to obtain optimized chords. Optimizing the chords based on the common chord group in the preset common chord library can make the optimized chords less prone to dissonant chords caused by out-of-tune in the to-be-processed humming audio, so that the final generated chord accompaniment audio is more in line with the user's listening experience.

Specifically, the chords are grouped to obtain different chord groups; and a current chord group is matched with each common chord group corresponding to the key in the preset common chord library, and the common chord group with a highest matching degree is determined as an optimized chord group corresponding to the current chord group until the optimized chord group corresponding to each chord group is obtained, to obtain the optimized chords.

That is, the current chord group is matched with each common chord group corresponding to the key in the preset common chord library, to obtain a matching degree between the current chord group and each common chord group. The common chord group with a highest matching degree is determined as an optimized chord group corresponding to the current chord group until the optimized chord group corresponding to each chord group is obtained, to obtain the optimized chords.

The chords are grouped to obtain different chord groups. Specifically, every four chords are considered as one chord group. If there is an empty chord without reaching four consecutive chords, the existing consecutive chords may be considered as one chord group.

For example, the chords are C, E, F, A, C, A, B, W, G, D, C, where W represents an empty chord, in this case, C, E, F, A are considered as one chord group, and C, A, B are considered as one chord group, and then G, D, C are considered as one chord group.

Referring to Table 2 below, the common chord groups in the common chord library include 9 chord groups corresponding to the major key, and 3 chord groups corresponding to the minor key. Apparently, the common chord groups in the common chord library may include more or less common chord groups, and other common chord group patterns. The specific common chord groups are not limited here, which may be set according to the actual situations.

TABLE 2

| Routine | | | | | | | | | | | | |
|---|---|---|---|---|---|---|---|---|---|---|---|---|
| Chord | Major key | | | | | | | | | Minor key | | |
| Sequence | 1 | 2 | 3 | 4 | 5 | 6 | 7 | 8 | 9 | 1 | 2 | 3 |
| First chord | F | F | Dm | Dm | C | F | F | F | C | Am | Am | Am |
| Second chord | G | G | G | G | G | G | G | Em | Am | F | G | F |
| Third chord | Em | C | C | Em | Am | Am | Am | Dm | F | C | F | Dm |
| Fourth chord | Am | Am | Am | Am | F | Am | G | C | G | G | G | Em |

The current chord group is matched with each common chord group corresponding to the key in the preset common chord library, to obtain a matching degree between the current chord group and each common chord group. Specifically, the current chord group is matched with the chord at the corresponding position in the first common chord group to determine the corresponding distance difference. The distance difference is an absolute value of an actual distance difference. A sum of the distance difference between the current chord group and each chord in the first common chord group is obtained. After the current chord group is matched with each common chord group corresponding to the key of the to-be-processed humming audio, the minimum distance difference and a corresponding common chord group are determined as the common chord group with the highest matching degree, i.e. the optimized chord group corresponding to the current chord group.

For example, the common chord group includes 4 chords (that is, 4 bars, 16 beats). Assume that an original recognized chord is (W, F, G, E, B, W, F, G, C, W), W is an empty chord without sound, and C, D, E, F, G, A, B correspond to 1, 2, 3, 4, 5, 6, 7 respectively. The chord after being added with m has the same corresponding value as the chord, for example, both C and Cm correspond to 1.

For F, G, E, and B, assuming that the key mode determined above is the major key, then matching is performed in the major key, and the distance difference sum of the distance differences is calculated. A first chord (F, G, Em, Am) correspond to a distance difference of (0, 0, 0, 1), so the distance difference sum is 1. A second chord (F, G, C, Am) correspond to a distance difference of (0, 0, 2, 1), and the distance difference sum is 3. After comparison, the distance difference sum corresponding to the first chord is the smallest, so the chord sequence may become (W, F, G, Em, Am, W, A, F, C, W).

The empty beat is skipped, the distance difference sum between F, G, C and the first three chords of the second major chord (F, G, C, Am) is 0, which is the smallest, and the final result is (W, F, G, Em, Am, W, F, G, C, W). If two distance difference sums are the same, the chord corresponding to a less sequence number is selected. For example, in a case that the distance difference sum between the chord group and the second major chord (F, G, C, Am) is 2 and the distance difference sum between the chord group and the first chord (F, G, Em, Am) is 2, the first chord (F, G, Em, Am) is determined as the optimized chord group corresponding to the current chord group.

Step S23: convert the optimized chords into optimized notes according to a pre-acquired correspondence between chords and notes.

After obtaining the optimized chords, it is also necessary to convert the optimized chords into the optimized notes according to the pre-acquired correspondence between the chords and the notes. Specifically, the correspondence between the chords and the notes is pre-acquired, so that after obtaining the optimized chords, the optimized chords are converted into the optimized notes according to the correspondence between the chords and the notes.

The optimized chords are more harmonious, avoiding chord dissonance caused by reasons such as out-of-tune when the user hums, so that the obtained chord accompaniment sounds more in line with the user's music experience.

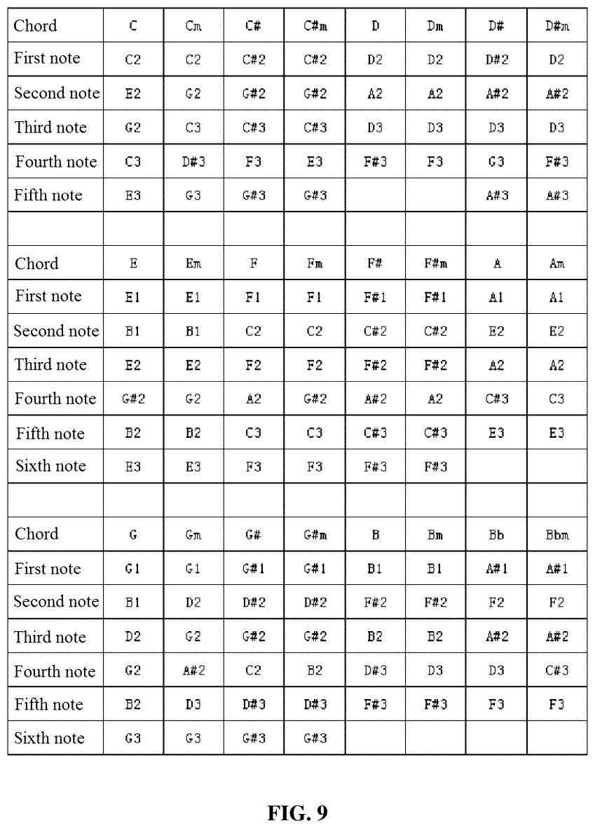

The correspondence for converting ordinary chords into piano notes is shown FIG. 8, one chord corresponds to four notes, and one beat corresponds to one note, that is, one chord generally corresponds to four beats.

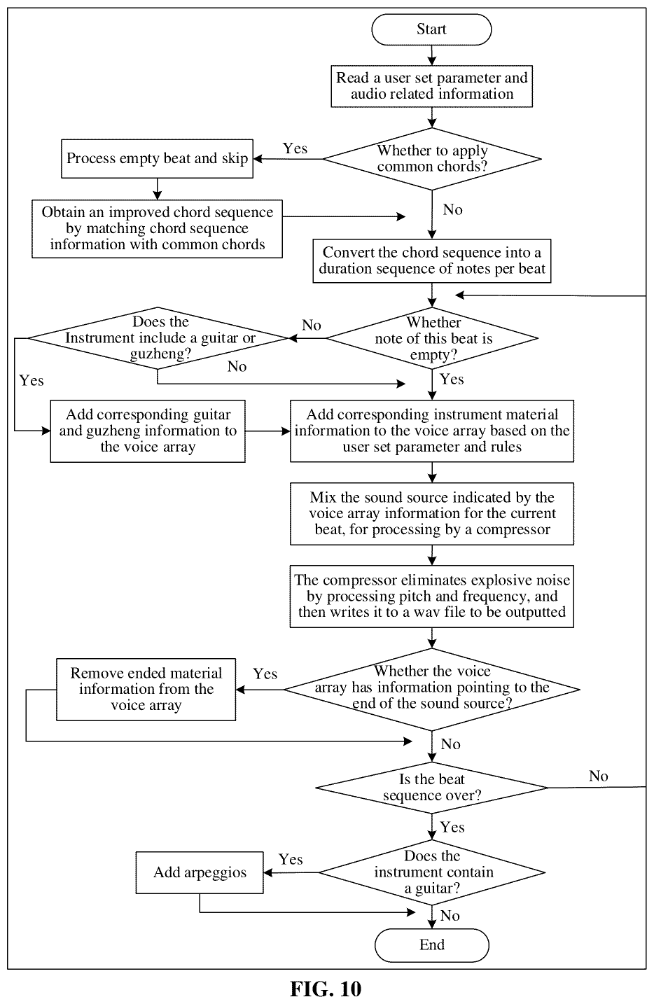

When playing notes on the guitar, it is needed to add arpeggios, and an arpeggios chord generally corresponds to 4 to 6 notes. The specific correspondence for converting the arpeggios into piano notes is shown in FIG. 9.

Step S24: determine audio material information corresponding to each note in the optimized notes based on an instrument type parameter and an instrument pitch parameter in the chord accompaniment parameter, and mix audio materials corresponding to the audio material information according to a preset mixing rule.

After the optimized chords are converted into the optimized notes, the audio material information corresponding to each note in the optimized notes is determined based on the instrument type parameter and the instrument pitch parameter in the chord accompaniment parameter, and the audio materials corresponding to the audio material information are mixed according to the preset mixing rule.

Specifically, the audio material information corresponding to each note in the optimized notes is determined based on the instrument type parameter and the instrument pitch parameter in the chord accompaniment parameter. The audio material information includes a material identifier, a pitch, a starting playback position and a material duration. The audio material information is putted into a preset voice array according to the preset mixing rule, and mixing is performed on audio materials in a preset audio material library indicated by the audio material information in the preset voice array for a current beat. The beat is determined according to the beat per minute information.

After obtaining the aforementioned beat per minute information (that is, BPM), the rhythm information of the chord accompaniment audio is obtained, that is, the beat per minute information may be used to determine how many notes need to be played evenly within each minute. The optimized note are represented as a note sequence, the notes are arranged in chronological order, and the time corresponding to each optimized note may be determined, that is, the position of each optimized note may be determined. Under normal rhythm (BPM is less than or equal to 200), one beat corresponds to one note, so the corresponding audio material information is putted into the preset voice array according to the preset mixing rule, and the mixing is performed on the audio materials in the preset audio material library indicated by the audio material information in the preset voice array for the current beat.

In the specific implementation, if there is the audio material information in the preset voice array points to the end of the audio material, it means that the audio material has been mixed this time, and the corresponding audio material information is removed from the preset voice array. If the optimized note sequence is to end, it is judged whether the instrument corresponding to the instrument type parameter includes a guitar. If the instrument includes a guitar, a corresponding arpeggio is added.

By mixing pre-processed audios played by different notes of various instruments, an effect similar to actual playing is obtained. The actual playing note may not disappear instantly, so a set of current voice sequence mechanism is required. A play pointer is set for the audio material that has not been played. The audio material that has not been played is stored in the voice array and is mixed with newly added audio material, the mixed materials are corrected by a compressor and then are written into a WAV file to be outputted, so as to achieve an accompaniment generation effect that is closer to the real playing.

The preset voice array records the material information that needs to be mixed at the current beat (the material information includes mainly a material identifier, each material content file corresponds to a unique identifier, a starting playback position and a material duration). An example of a mixing process is as follows. Assuming that the BPM of an original audio hummed by the user is identified as 60, that is, each beat occupies 60/60=1 second. Taking the first 4 beats as an example, if one audio material is added for each beat, the durations are 2 seconds, 3 seconds, 2 seconds, 2 seconds respectively, and the material identifiers (IDs) are respectively 1, 2, 1, 4 (that is, the first beat and the third beat use the same material). Therefore, in the first beat, the voice array is [(1, 0)], (1, 0) means that the material ID=1, the starting position is 0, then information from 0-1 second in the material with material ID=1 is (starting is 0, and one beat lasts for 1 second, so the ending is 1) is written to the output (hereinafter referred to as the output) through the compressor. When the second beat starts, the first material still has 1 second to end, the starting position becomes 1, and the material of the second beat starts, at this time, the voice array is [(1, 1), (2, 0)], the information of 1-2 second of material with the material ID=1 is mixed with the content of 0-1 second of material with the material ID=2, and then mixed content is outputted. When the third beat starts, the material of the first beat has been played completely, the vocie array is displayed, the material ID=1 of the third beat is the same as the material ID=1 of the first beat, in this case, the voice array is [(2,1), (1,0)], the information of 1-2 second of material with the material ID=2 is mixed with the content of 0-1 second of material with the material ID=1, and then mixed content is outputted. When the fourth beat starts, the voice array is [(2, 2), (1, 1), (4, 0)], the content of the three materials at corresponding times are outputted. When the fourth beat ends, the voice array is [(4, 1)], and the voice array is sent to the next beat, and display of other material information is ended.

In this way, the audio material and the audio material information are separated processed, the audio material and the audio material information are corresponded by the audio material identifier in an audio material mapping table. When same notes of the same instrument appear repeatedly in the accompaniment, the audio material only needs to be loaded once, which avoids a large reading and writing delay caused by repeated reading and writing, so as to save time.

In practice, a certain rule i.e. the preset mixing rule is required when mixing audio materials of different musical instruments. Term “playing” in the following rule refers to adding the audio material information to the voice array. The rule is as follows.

The basis of guitar accompaniment playing is chord patterns extracted from the audio. At normal speed, the optimized chord sequence is obtained by selecting whether to match common chords, and then the optimized chord sequence is converted into notes of each beat according to a rhythm rule, for a mixing process. When the BPM exceeds 200, it may switch to a chorus mode. Except the first beat is normal, all remaining notes included in the current chord are played in the second and fourth beats, and the current voice array is cleared away and syncopation and percussion material are added in the third beat. Chorus mode leads to a more upbeat mode. At the end of the accompaniment, there is an arpeggio syllable sequence based on an ending chord pattern and obtained through an arpeggio conversion principle. The duration of the last syllable is stretched to be half of a bar, and the other syllables are played at a uniform speed in the first half of the bar to achieve an effect of ending arpeggio.

The playing manner of Guzheng is the same as the playing manner of the guitar at normal speed, but arpeggio is not added for Guzheng.

The above is the rules of chord instruments, and the guitar is taken as an example to explain the rule. For example, when one bar includes 4 beats, one chord exactly corresponds to one bar under normal speed. Each chord has 4 notes, so exactly one note is played per beat.

When the BPM exceeds 200 (that is, each beat<0.3 second, fast rhythm mode), it is set to the chorus mode, the first note of the chord is played in the first beat, and the second, third, and fourth notes of the chord are played at the same time in the second beat. In the third beat, the percussion and syncopation materials are played, and all the remaining guitar audio material information is removed from the voice array. The operation in the fourth beat is the same as the operation in the second beat, so as to create a cheerful atmosphere.

After the chord sequence other than the empty chord is played, an arpeggio related to the last non-empty chord is added, and the arpeggio includes 4-6 notes (which is related to the chord type and belongs to the conventional art). In a process of playing a bar, taking a bar including 4 beats and 6 notes of arpeggio as an example, the first 5 notes are played in the first two beats, that is, each note is played for 0.4 beat and then the next note is played, and then the last note is played at the starting of the third beat until the end of the bar, and the last note lasts for 2 beats.

Bass drum and cajon drum are described as follow. The rhythm of the drum includes two kinds of timbres, which are Kick and Snare. Kick of the bass Drum hits harder and Snare of the bass Drum hits lighter. However, Kick of the cajon drum hits lighter and Snare of the cajon drum hits harder. The Kick timbre is in a unit of bar, and appears on the front beat of the first beat, ¾ beat of the second beat, and the backbeat of the third beat. One Snare timbre corresponds to two beats, and appears on the front beat of the second beat.

Electronic sound refers to a timbre generated by combining timpani, hi-hat and bass in the drum kit. The timpani also includes two kinds of timbres which are Kick and Snare. A rule for the Snare timbre of the timpani is the same as that of bass drum. The Kick timbre appears on the front beat of each beat; the hi-hat and bass appear on the backbeat of each beat. The key played by the bass maps with that of the guitar tone. When there is no mapping, the standard tone is used.

Maracas includes hard and soft timbres. Two hard timbres correspond to one beat, and two soft timbres correspond to one beat. Hard sounds on front beat and backbeat, and soft sounds on ¼ beat and ¾ beat.

The above percussion instrument rule is explained as follows. For a bar includes 4 beats, its duration may be understood as the interval of [0, 4). 0 is the beginning of the first beat, and 4 is the end of the fourth beat. One timbre corresponds to one material. The front beat represents the first half of the beat, for example, the start time of the front beat of the first beat is 0, and the start time of the front beat of the second beat is 1. The backbeat represents the second half of a beat. That is, the start time of the backbeat of the first beat is 0.5, and the start time of the backbeat of the second beat is 1.5. Therefore, ¼ beat, ¾ beat mean that the insertion time of the material is at 0.25, 0.75 of a beat.

Step S25: write the mixed audio into a WAV file to obtain the chord accompaniment audio corresponding to the to-be-processed humming audio.

After mixing the corresponding audio materials, the mixed audio may be written into a WAV file to obtain the chord accompaniment audio corresponding to the to-be-processed humming audio. Before writing the mixed audio into the WAV file, the mixed audio may be processed by the compressor to prevent explosive noise after mixing.

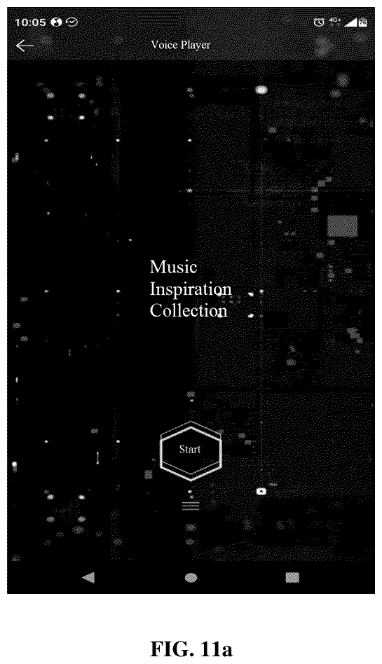

FIG. 10 is a flow chart of generating a chord accompaniment. First a user set parameter is read, that is, the chord accompaniment generation parameter is acquired. In addition, audio related information is also needs to be obtained, the audio related information refers to the aforementioned beat per minute information, the chords. Then it is determined whether to apply common chords, that is, whether the chord parameter in the chord accompaniment parameter represents common chords. If the chord parameter in the chord accompaniment parameter represents common chords; the empty chords in the chord sequence are skipped, and other chords are matched with common chords to obtain improved chords, that is, optimized chords; the optimized chords are converted into a duration sequence of notes per beat, and it is determined whether note of this beat is empty. If the note of this beat is not empty, it is determined whether the instrument type parameter in the user set parameter includes a parameter corresponding to a guitar or guzheng. If the instrument includes a guitar or guzheng, corresponding guitar and guzheng information is added to the preset voice array, and corresponding audio material information is added to the voice array based on the user set parameter and rules. If the note of this beat is empty, corresponding audio material information is directly added to the voice array based on the user set parameter and rules, and the sound source (audio material) indicated by the audio material information in the voice array for the current beat is mixed for processing by the compressor. After the compressor eliminates explosive noise, and the data is written to a way file. It is determined whether the voice array has audio material information pointing to the end of the audio material. If the voice array has audio material information pointing to the end of the audio material, ended material information is remove from the voice array. If the voice array does not have audio material information pointing to the end of the audio material, it is determined whether the beat sequence is over. If the beat sequence is over, it is determined whether the instrument contain a guitar. If the instrument contain a guitar, an arpeggio is added, and then the process is ended. If the instrument does not contain a guitar, the process is directly ended.

In the actual implementation, in the above-mentioned audio processing method, the to-be-processed humming audio may be obtained by the terminal, and the acquired to-be-processed humming audio may be sent to the corresponding server. The server performs subsequent processing to obtain the MIDI file and the chord accompaniment audio corresponding to the to-be-processed humming audio, and then returns the generated MIDI file and the chord accompaniment audio to the terminal. In this way, the server is used for processing, which can improve the processing speed.

Alternatively, each step in the aforementioned audio processing method may be performed on the terminal. When the aforementioned entire audio processing process is performed on the terminal, the problem of service unavailability, caused by the terminal being unable to connect to the corresponding server when the network is disconnected, can be avoided.

When performing music information retrieval on the to-be-processed humming audio, it is also possible to identify music information by deploying technologies such as a neural network on the server device, and implement the extraction task of the terminal with the help of the network. The neural network may be miniaturized and deployed on the terminal device to avoid network connection errors.

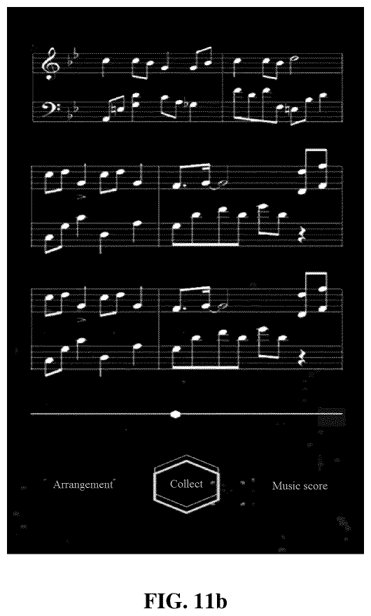

FIG. 11 shows a specific implementation of the aforementioned audio processing method, taking a trial version of APP (Application, mobile phone software) as an example. First, after entering the APP through the home page shown in FIG. 11a, the user hums through the microphone, and the terminal device may obtain the audio stream inputted by humming through sampling. The audio stream is identified and processed. After the humming is completed, the corresponding music information such as BPM, chords, note and pitches are acquired immediately. As shown in FIG. 11b, the acquired music information is displayed in the form of a score. Subsequently, as shown in FIG. 11c, the user may choose four styles of national style, folk songs, playing and singing, and electronic sound according to his own preferences, or freely choose the rhythm speed, chord mode, instruments and their occupation through a customization mode. After obtaining these chord generation parameters, the background may generate the chord accompaniment audio according to these chord generation parameters, and generate a MIDI file corresponding to the user's humming audio according to the music information. In this way, an accompaniment audio conforming to the melody rhythm and notes of the original humming audio may be generated based on the parameters selected by the user and the music information obtained by using the MIR technology, the accompaniment audio is used the user to listen to.

In this way, when using the APP in the above picture, the user can hum a few words into the microphone at will. The APP obtains the corresponding to-be-processed humming audio. Through simple parameter settings, the user can experience the accompaniment effects of various instruments and can also try different genres or styles, and can also arbitrarily combine guzheng, guitar, drums and other instruments to enrich the melody and generate the most suitable accompaniment.

After post-processing, the melody generated by the user's humming audio is perfectly combined with the synthesized chord accompaniment to form an excellent music work and store it. More usage scenarios may be developed, such as building a user community, so that users can upload their own works for communication; cooperating with professionals, uploading more instrument style templates, etc.

Moreover, the operation method for implementing the functions in the above figure is simple, and can make full use of the fragmented time of the users. The users may be young people who like music and not limited to professional groups, and the audience is wider. The youthful interface can attract more emerging young groups. By adjusting the track editing methods of existing professional music software, user interaction can be simplified to achieve the goal of mainstream non professionals getting started faster.

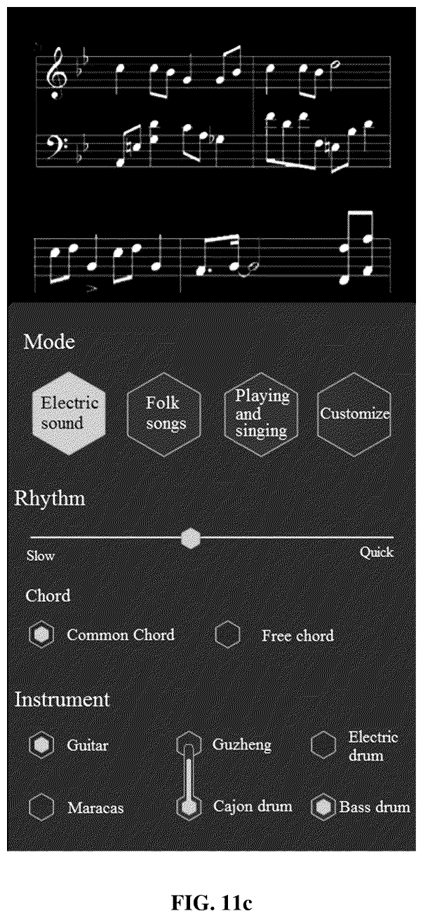

Referring to FIG. 12, the embodiment of the present disclosure provides an audio processing apparatus, which includes: an audio acquisition module 201, configured to acquire a to-be-processed humming audio and music information corresponding to the to-be-processed humming audio, the music information including note information and beat per minute information; a chord determination module 202, configured to determine chords corresponding to the to-be-processed humming audio based on the note information and the beat per minute information; an MIDI file generation module 203, configured to generate an MIDI file corresponding to the to-be-processed humming audio based on the note information and the beat per minute information; a chord accompaniment generating module 204, configured to generate a chord accompaniment audio corresponding to the to-be-processed humming audio based on the beat per minute information, the chords and a pre-acquired chord accompaniment parameter, the chord accompaniment parameter being a chord accompaniment generation parameter set by a user; and an output module 205, configured to output the MIDI file and the chord accompaniment audio.

It can be seen that in this disclosure, a to-be-processed humming audio and music information corresponding to the to-be-processed humming audio are acquired, the music information includes note information and beat per minute information; then chords corresponding to the to-be-processed humming audio are determined based on the note information and the beat per minute information; an MIDI file corresponding to the to-be-processed humming audio is generated based on the note information and the beat per minute information; a chord accompaniment audio corresponding to the to-be-processed humming audio are generated based on the beat per minute information, the chords and a pre-acquired chord accompaniment parameter, and finally the MIDI file and the chord accompaniment audio are outputted. It can be seen that in this disclosure, corresponding music information can be obtained after the to-be-processed humming audio is acquired. Compared with the conventional art, it is not necessary to first convert the to-be-processed humming audio into a MIDI file, and then analyze the MIDI file, therefore, it is not prone to the problem of cumulative errors caused by converting the audio to the MIDI file. In addition, not only the MIDI file corresponding to a main melody audio needs to be generated based on the music information, but also the corresponding chord accompaniment audio needs to be generated according to the music information and the chords. Compared with the problem of inconsistency user experiences in the conventional art cause by only generating the MIDI file corresponding to chord accompaniment, in this disclosure, not only the MIDI file corresponding to a main melody of the to-be-processed humming audio is generated, but also the corresponding chord accompaniment of the to-be-processed humming audio is generated. The chord accompaniment audio is less dependent on the performance of the audio device, therefore the experiences of different users are consistent, and the expected user experience effect is achieved.

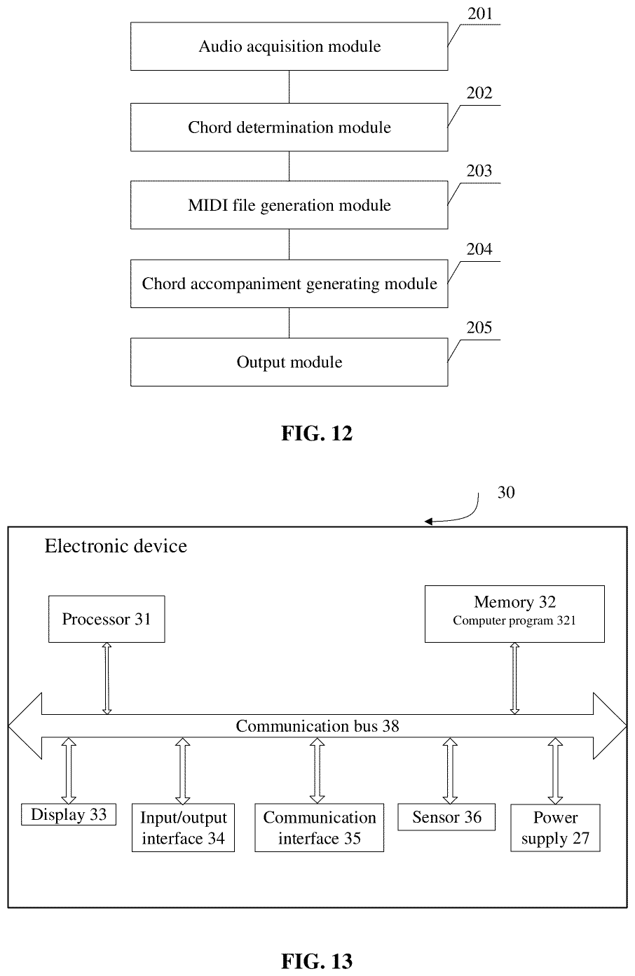

FIG. 13 is a schematic structural diagram of an electronic device 30 provided in an embodiment of the present disclosure. The user terminal may specifically include, but not limited to, a smart phone, a tablet computer, a notebook computer, or a desktop computer.

Generally, the electronic device 30 in this embodiment includes: a processor 31 and a memory 32.

The processor 31 may include one or more processing cores, such as a quad-core processor, an octa-core processor. The processor 31 may be implemented by at least one hardware of DSP (digital signal processing), FPGA (field-programmable gate array), PLA (programmable logic array). The processor 31 may also include a main processor and a coprocessor. The main processor is a processor for processing data in the wake-up state, and is also called a CPU (central processing unit). The coprocessor is a low-power processor for processing data in standby state. In some embodiments, the processor 31 may be integrated with a GPU (graphics processing unit), and the GPU is used for rendering and drawing images to be displayed on the display. In some embodiments, the processor 31 may include an AI (artificial intelligence) processor, where the AI processor is used to process computing operations related to machine learning.

The memory 32 may include one or more computer-readable storage media, which may be non-transitory. The memory 32 may also include high-speed random access memory, and non-volatile memory, such as one or more magnetic disk storage devices, flash memory storage devices. In this embodiment, the memory 32 is at least used to store the following computer program 321. After the computer program is loaded and executed by the processor 31, the steps of the audio processing method disclosed in any of the foregoing embodiments are performed.

In some embodiments, the electronic device 30 may further include a display 33, an input/output interface 34, a communication interface 35, a sensor 36, a power supply 37 and a communication bus 38.

Those skilled in the art can understand that the structure shown in FIG. 13 does not constitute a limitation on the electronic device 30, and may include more or less components than those shown in the illustration.

Further, the embodiment of the present disclosure also discloses a computer-readable storage medium for storing computer programs. The computer programs, when executed by a processor, perform the audio processing method disclosed in any of the foregoing embodiments.

For the specific process of the above audio processing method, reference may be made to the corresponding content disclosed in the foregoing embodiments, and details are not repeated here.

Each embodiment in this specification is described in a progressive manner, each embodiment focuses on the difference from other embodiments, and the same or similar parts of each embodiment can be referred to each other. For the apparatus disclosed in the embodiment, because it corresponds to the method disclosed in the embodiment, the description is relatively simple. For relevant information, please refer to the description of the method part.

The steps of the methods or algorithms described in connection with the embodiments disclosed herein may be directly implemented by hardware, software modules executed by a processor, or a combination of both. Software modules may be placed in random access memory (RAM), internal memory, read-only memory (ROM), electrically programmable ROM, electrically erasable programmable ROM, registers, hard disk, removable disk, CD-ROM, or any other any other known storage medium.

Finally, it should also be noted that in this document, relational terms such as “first” and “second” are only used to distinguish one entity or operation from another, and do not necessarily require or imply that an actual relationship or order exists between these entities or operations. Furthermore, the terms “comprise”, “include” or any other variation thereof are intended to cover a non-exclusive inclusion such that a set of process, method, article, or apparatus including other elements includes not only those elements, but also includes elements not expressly listed, and elements inherent in such process, method, article or apparatus. Without further limitations, an element defined by the phrase “comprising a . . . ” does not exclude the presence of additional identical elements in the process, method, article or apparatus including said element.

An audio processing method, apparatus, device and medium provided by this disclosure have been introduced in detail above. In this article, specific examples are used to illustrate the principle and implementation of this disclosure. The description of the above embodiments is only for helping understanding the method of this disclosure and its core idea. In addition, for those of ordinary skill in the art, according to the idea of this disclosure, there may be changes in the specific implementation and the application scope. In summary, the content of this specification should not understood as a limitation of the disclosure.

1. An audio processing method, comprising:
acquiring a to-be-processed humming audio and music information corresponding to the to-be-processed humming audio, the music information comprising note information and beat per minute information;
determining chords corresponding to the to-be-processed humming audio based on the note information and the beat per minute information;
generating an MIDI file corresponding to the to-be-processed humming audio based on the note information and the beat per minute information;
generating a chord accompaniment audio corresponding to the to-be-processed humming audio based on the beat per minute information, the chords and a pre-acquired chord accompaniment parameter, the chord accompaniment parameter being a chord accompaniment generation parameter set by a user; and
outputting the MIDI file and the chord accompaniment audio.

2. The audio processing method according to claim 1, wherein the acquiring a to-be-processed humming audio and music information corresponding to the to-be-processed humming audio comprises:
acquiring the to-be-processed humming audio;
determining a target fundamental tone period of each first audio frame in the to-be-processed humming audio, and determining note information corresponding to the first audio frame based on the target fundamental tone period, wherein the first audio frame has a first preset duration; and
determining an acoustic energy of each second audio frame in the to-be-processed humming audio, and determining the beat per minute information corresponding to the to-be-processed humming audio based on the acoustic energy, wherein the second audio frame comprises a preset number of sampling points.

3. The audio processing method according to claim 2, wherein the determining a target fundamental tone period of each first audio frame in the to-be-processed humming audio comprises:
determining the target fundamental tone period of the first audio frame in the to-be-processed humming audio by using a short-time autocorrelation function and a preset unvoiced or voiced sound detection method.

4. The audio processing method according to claim 3, wherein determining the target fundamental tone period of the first audio frame in the to-be-processed humming audio by using a short-time autocorrelation function and a preset unvoiced or voiced sound detection method comprises:
determining a preselected fundamental tone period of the first audio frame in the to-be-processed humming audio by using the short-time autocorrelation function;
determining whether the first audio frame is a voiced sound frame by using the preset unvoiced or voiced sound detection method; and
determining the preselected fundamental tone period of the first audio frame as the target fundamental tone period of the first audio frame in a case that the first audio frame is a voiced sound frame.

5. The audio processing method according to claim 2, wherein the determining note information corresponding to the first audio frame based on the target fundamental tone period comprises:
determining a pitch of the first audio frame based on the target fundamental tone period;
determining a note corresponding to the first audio frame based on the pitch of the first audio frame; and
determining the note corresponding to the first audio frame and starting and ending time instants corresponding to the first audio frame as the note information corresponding to the first audio frame.

6. The audio processing method according to claim 2, wherein the determining an acoustic energy of each second audio frame in the to-be-processed humming audio and determining the beat per minute information corresponding to the to-be-processed humming audio based on the acoustic energy comprises:
determining an acoustic energy of a current second audio frame and an average acoustic energy corresponding to the current second audio frame in the to-be-processed humming audio, wherein the average acoustic energy is an average value of acoustic energies of the second audio frames in a continuous second preset duration before an ending time instant of the current second audio frame;
constructing a target comparison parameter based on the average acoustic energy;
determining whether the acoustic energy of the current second audio frame is greater than the target comparison parameter; and
determining, in a case that the acoustic energy of the current second audio frame is greater than the target comparison parameter, that the current second audio frame comprises one beat until detection of each second audio frame in the to-be-processed humming audio is completed, to obtain a total number of beats in the to-be-processed humming audio, and determining the beat per minute information corresponding to the to-be-processed humming audio based on the total number of beats.

7. The audio processing method according to claim 6, wherein the constructing a target comparison parameter based on the average acoustic energy comprises:
determining an offset sum of an offset of the acoustic energy of each second audio frame, in the continuous second preset duration before the ending time instant of the current second audio frame, relative to the average acoustic energy;
determining a calibration factor for the average acoustic energy based on the offset sum; and
calibrating the average acoustic energy based on the calibration factor to obtain the target comparison parameter.

8. The audio processing method according to claim 1, wherein the determining chords corresponding to the to-be-processed humming audio based on the note information and the beat per minute information comprises:
determining a key of the to-be-processed humming audio based on the note information;
determining preselected chords from preset chords based on the key of the to-be-processed humming audio; and
determining chords corresponding to the to-be-processed humming audio from the preselected chords based on the note information and the beat per minute information.

9. The audio processing method according to claim 8, wherein the determining a key of the to-be-processed humming audio based on the note information comprises:
determining a real-time key feature corresponding to a note sequence in the note information when a preset adjustment parameter takes different values;
matching each real-time key feature with a preset key feature, and determining the real-time key feature with a highest matching degree as a target real-time key feature; and
determining the key of the to-be-processed humming audio based on a value of the preset adjustment parameter corresponding to the target real-time key feature, and a correspondence between values, of the preset adjustment parameter corresponding to a preset key feature that best matches the target real-time key feature, and keys.

10. The audio processing method according to claim 8, wherein the determining chords corresponding to the to-be-processed humming audio from the preselected chords based on the note information and the beat per minute information comprises:
dividing notes in the note information into different bars according to time sequence based on the beat per minute information; and
matching the notes in each bar with each of the preselected chords and determining the chord corresponding to the bar, to determine the chords corresponding to the to-be-processed humming audio.

11. The audio processing method according to claim 1, wherein the generating a chord accompaniment audio corresponding to the to-be-processed humming audio based on the beat per minute information, the chords and a pre-acquired chord accompaniment parameter comprises:
determining whether a chord parameter in the chord accompaniment parameter represents a common chord;
optimizing, if the chord parameter in the chord accompaniment parameter represents the common chord, the chords based on a common chord group in a preset common chord library to obtain optimized chords;
converting the optimized chords into optimized notes according to a pre-acquired correspondence between chords and notes;
determining audio material information corresponding to each note in the optimized notes based on an instrument type parameter and an instrument pitch parameter in the chord accompaniment parameter, and mixing audio materials corresponding to the audio material information according to a preset mixing rule; and
writing the mixed audio into a WAV file to obtain the chord accompaniment audio corresponding to the to-be-processed humming audio.

12. The audio processing method according to claim 11, wherein the optimizing the chords based on a common chord group in a preset common chord library to obtain optimized chords comprises:
determining a key of the to-be-processed humming audio based on the note information;
grouping the chords to obtain different chord groups; and
matching a current chord group with each common chord group corresponding to the key in the preset common chord library, and determining the common chord group with a highest matching degree as an optimized chord group corresponding to the current chord group until the optimized chord group corresponding to each chord group is obtained, to obtain the optimized chords.

13. The audio processing method according to claim 11, wherein the determining audio material information corresponding to each note in the optimized notes based on an instrument type parameter and an instrument pitch parameter in the chord accompaniment parameter, and mixing audio materials corresponding to the audio material information according to a preset mixing rule comprises:
determining the audio material information corresponding to each note in the optimized notes based on the instrument type parameter and the instrument pitch parameter in the chord accompaniment parameter, wherein the audio material information comprises a material identifier, a pitch, a starting playback position and a material duration; and
putting the audio material information into a preset voice array according to the preset mixing rule, and mixing audio materials in a preset audio material library indicated by the audio material information in the preset voice array for a current beat, wherein the beat is determined according to the beat per minute information.

14. An audio processing apparatus, comprising:
an audio acquisition module, configured to acquire a to-be-processed humming audio and music information corresponding to the to-be-processed humming audio, the music information comprising note information and beat per minute information;
a chord determination module, configured to determine chords corresponding to the to-be-processed humming audio based on the note information and the beat per minute information;
an MIDI file generation module, configured to generate an MIDI file corresponding to the to-be-processed humming audio based on the note information and the beat per minute information;
a chord accompaniment generating module, configured to generate a chord accompaniment audio corresponding to the to-be-processed humming audio based on the beat per minute information, the chords and a pre-acquired chord accompaniment parameter, the chord accompaniment parameter being a chord accompaniment generation parameter set by a user; and
an output module, configured to output the MIDI file and the chord accompaniment audio.

15. An electronic device, comprising:
a memory configured to store computer programs; and
a processor configured to execute the computer programs to implement an audio processing method comprising:
acquiring a to-be-processed humming audio and music information corresponding to the to-be-processed humming audio, the music information comprising note information and beat per minute information;
determining chords corresponding to the to-be-processed humming audio based on the note information and the beat per minute information;
generating an MIDI file corresponding to the to-be-processed humming audio based on the note information and the beat per minute information;
generating a chord accompaniment audio corresponding to the to-be-processed humming audio based on the beat per minute information, the chords and a pre-acquired chord accompaniment parameter, the chord accompaniment parameter being a chord accompaniment generation parameter set by a user; and
outputting the MIDI file and the chord accompaniment audio.

16. A computer-readable storage medium storing computer programs, the computer programs, when executed by a processor, performing the audio processing method according to claim 1.
